(19) United States
(12) Patent Application Publication
(10) Pub. No.: US 2022/0253409 A1
(43) Pub. Date: Aug. 11, 2022

(54) CLEANING COMPENSATED CHANGE RECORDS IN TRANSACTION LOGS

(71) Applicant: INTERNATIONAL BUSINESS MACHINES CORPORATION, ARMONK, NY (US)

(72) Inventors: Felix Beier, Haigerloch (DE); Knut Stolze, Hummelshain (DE); Reinhold Geiselhart, Rottenburg-Ergenzingen (DE); Luis Eduardo Oliveira Lizardo, Böblingen (DE)

(21) Appl. No.: 17/168,825

(22) Filed: Feb. 5, 2021

(51) Int. Cl. G06F 16/18; G06F 16/17; G06F 16/11; G06F 16/13

(52) U.S. Cl. CPC G06F 16/1865; G06F 16/137; G06F 16/128; G06F 16/1734

(57) ABSTRACT

Disclosed is a method of operating a computer implemented database. The method comprises: receiving log records descriptive of database transactions from a source database; writing the log records to a transaction log; reading at least a portion of the log records to a temporary log record buffer; searching the temporary log record buffer to identify compensated log entries; and modifying the transaction log using the compensated log entries.

### BACKGROUND

The present invention relates to the field of database management systems, and more specifically, to a method for improving the performance of transaction logs for database systems.

During the restoration of a database system, a snapshot or previously stored version of the database system is recalled. The database system is then rebuilt to its most recent state by applying transactions stored in a transaction log and/or log archive that stores database transactions.

### BRIEF SUMMARY

In one aspect the invention relates to a method of operating a computer-implemented database. The method comprises receiving log records descriptive of database transactions from the computer-implemented database. The method further comprises writing the log records to a transaction log. The method further comprises reading at least a portion of the log records to a temporary log record buffer. The method then further comprises searching the temporary log record buffer to identify compensated log entries. The method further comprises modifying the transaction log using the compensated log entries.

In another aspect, the invention provides for a computer program product comprising a computer-readable storage medium that has computer-readable program code embodied therewith. The computer-readable program code is configured to implement the method.

In another aspect the invention provides for a computer system that comprises a processor configured for controlling the computer system. The computer system further comprises a memory storing machine-executable instructions. Execution of the instructions causes the processor to receive log records descriptive of database transactions from the source database. Execution of the instructions further causes the processor to write the log records to the transaction log. Execution of the machine-executable instructions further causes the processor to read at least a portion of the log records to a temporary log record buffer. Execution of the instructions further causes the processor to search the temporary log record buffer to identify compensated log entries. Execution of the instructions further causes the processor to modify the transaction log using the compensated log entries.

### BRIEF DESCRIPTION OF THE DRAWINGS

In the following embodiments of the invention are explained in greater detail, by way of example only, making reference to the drawings in which:

FIG. 1 illustrates an implementation of a computer system;

FIG. 2 illustrates an exemplary computing environment where the computer system of claim 1 is connected to a network;

FIG. 3 illustrates an example of a computer implemented database implemented using the computer system of FIG. 1;

FIG. 4 illustrates a further example of a computer implemented database implemented using the computer system of FIG. 1;

FIG. 5 illustrates the use of an auxiliary data structure to mark a compensated log record;

FIG. 6 illustrates the use of an extended log record to mark a compensated log record;

FIG. 7 illustrates the use of an extended block of log records to mark multiple compensated log records; and

FIG. 8 illustrates a method of operating a computer implemented database.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

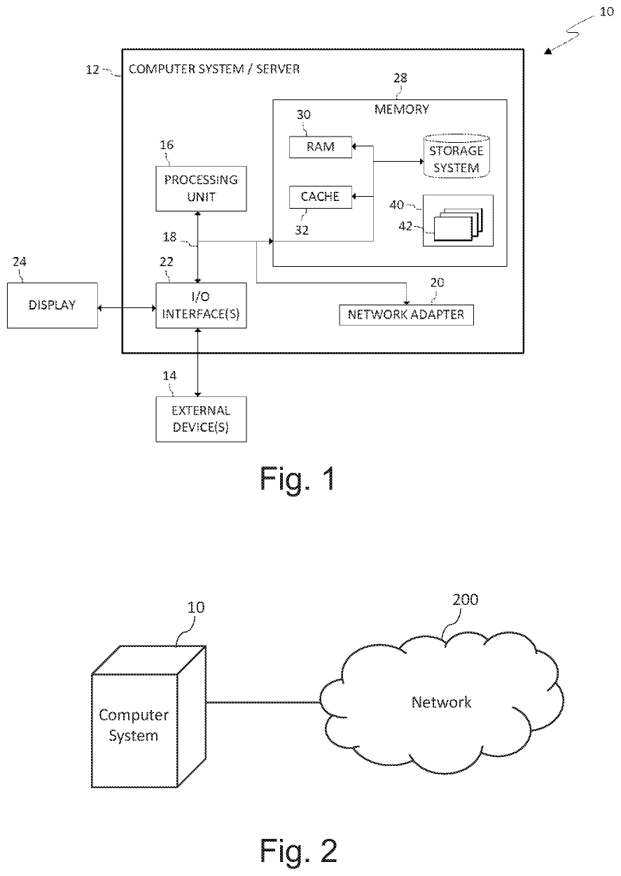

Embodiments of the present invention may be implemented using a computing device that may also be referred to as a computer system, a client, or a server. Referring now to FIG. 1, a schematic of an example of a computer system is shown. Computer system 10 is only one example of a suitable computer system and is not intended to suggest any limitation as to the scope of use or functionality of embodiments of the invention described herein. Regardless, computer system 10 is capable of being implemented and/or performing any of the functionality set forth hereinabove.

In computer system 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computer system 10 is shown in the form of a general-purpose computing device. The components of computer system/server 12 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

A computer system such as the computer system 10 shown in FIG. 1 may be used for performing operations disclosed herein such as storing log records descriptive of database transactions. Such computer system may be a standalone computer with no network connectivity that may receive data to be processed, such as receiving log records, through a local interface. Such operation may, however, likewise be performed using a computer system that is connected to a network such as a communications network and/or a computing network.

FIG. 2 shows an exemplary computing environment where a computer system such as computer system 10 is connected, e.g., using the network adapter 20, to a network 200. Without limitation, the network 200 may be a communications network such as the internet, a local-area network (LAN), a wireless network such as a mobile communications network, and the like. The network 200 may comprise a computing network such as a cloud-computing network. The computer system 10 may receive data to be processed, such as log records, from the network 200 and/or may provide a computing result, such as providing a modified transaction log, to another computing device connected to the computer system 10 via the network 200.

The computer system 10 may perform operations described herein, entirely or in part, in response to a request received via the network 200. In particular, the computer system 10 may perform such operations in a distributed computation together with one or more further computer systems that may be connected to the computer system 10 via the network 200. For that purpose, the computing system 10 and/or any further involved computer systems may access further computing resources, such as a dedicated or shared memory, using the network 200.

Embodiments may provide for a method of operating a computer implemented database that modifies the transaction log using compensated log entries. Compensated log entries may, for example, either be log entries which have not actually been used to update the computer-implemented database or log entries which represent changes which were made obsolete by a later change. Examples of this are, for example, a transaction that was not committed but was rolled back, a transaction that encodes the change that has been overridden by a subsequent transaction.

The modification of the transaction log using the compensated log entries may be performed in a variety of ways. This modification may, for example, be a logical or virtual modification, for example, the compensated log entries may be recorded or marked so that they could be skipped during a restore operation of the computer-implemented database. In other examples the transaction log itself is actually modified to remove the compensated log entries.

In another embodiment modifying the transaction log using the compensated log entries comprises removing at least a portion of the compensated log entries from the transaction log. This, for example, may decrease the amount of time needed to rebuild the computer-implemented database using the transaction log.

In another embodiment reading at least a portion of the log records to a temporary log record buffer comprises reading a first set of blocks from the transaction log to the log record buffer and parsing each of the first set of blocks to identify a change record type. The searching of the temporary log record buffer to identify a compensated log entry comprises identifying compensated log entries in the first set of blocks as log entries, which are either rolled back transactions or are compensated by later log entries using the change record type. A later log entry is a log entry which occurred at a later time. The modifying of the transaction log using the compensated log entries comprises constructing a second set of blocks by removing the compensated log entries from the first set of blocks and replacing the first set of blocks in the transaction log with the second set of blocks. In this example the first set of blocks are essentially overwritten with the second set of blocks. This effectively removes the compensated log entries.

In another embodiment the replacing of the first set of blocks in the transaction log with a second set of blocks comprises removing the first set of blocks and appending the second set of blocks to the transaction log.

In another embodiment the replacing of the first set of blocks in the transaction log with a second set of blocks comprises overwriting the first set of blocks with the second set of blocks, which may, for example, preferably remove portions of the first set of blocks not overwritten by the second set of blocks.

In another embodiment the replacing of the first set of blocks in the transaction log with a second set of blocks comprises overwriting the first set of blocks with the second set of blocks. In further examples, this may retain the portions of the first set of blocks not overwritten by the second set of blocks. This, for example, may enable the reuse of the data which is not overwritten.

In another embodiment the method further comprises sorting and grouping of log entries of the second set of blocks according to a clustering criterion. This embodiment may be beneficial because operations which are related or similar may, for example, be executed simultaneously during a restore of the database.

The sorting and grouping of the second set of blocks may, for example, be performed using a hash table sorting algorithm. The use of a hash table may be beneficial because it may enable efficient sorting of the second set of blocks.

In another embodiment the clustering criterion is selected to order the log entries of the second set of blocks to order records by a table that is affected by the corresponding change or by table attributes that is affected by the corresponding change. This embodiment may be beneficial because it may enable the log entries, which are clustered together, to be performed simultaneously and thereby accelerate the restore of the computer-implemented database.

In another embodiment the method further comprises executing clustered log entries in the second set of blocks as a single operation during restoring the computer-implemented database. This may reduce the total number of database queries which are executed which may reduce the amount of time as well as computing and memory resources necessary to restore the computer-implemented database.

In another embodiment the modification of the transaction log using the compensated log entries comprises identifying the compensated log entries in the transaction log. In this example, instead of physically deleting them, they may be labeled, or an external file may be used to identify compensated log entries. This for example, may enable them to be skipped during a restore operation.

In another embodiment the identification of the compensated log entries in the transaction log is stored as an auxiliary data structure stored separately from the transaction log. For example, there may be a separate database which stores this data or a file in which this data is stored. The modification of the transaction log is a logical modification of the transaction log. The logical modification may also be considered to be a virtual modification. During the logical modification of the transaction logs, compensated log entries are ignored, and the process is accelerated as if these records had been physically removed from the transaction log.

In another embodiment, during the restoration of the computer-implemented database, the method further comprises accessing the auxiliary data structure during accessing the transaction log to identify the compensated log entries. The method further comprises, in this case, skipping the compensated log entries during restoration of the computer-implemented database. This method may be beneficial because it may enable the acceleration of the restoration of the computer-implemented database.

In another embodiment the identification of the compensated log entries in the transaction log is stored in the transaction log. This may be beneficial because it may provide for an efficient means of skipping the compensated log entries.

In another embodiment the compensated log entries in the transaction log are identified logically by using block header fields, by using log record headers, or by using compensated record entries. All of these may provide efficient means of modifying the transaction log to identify the compensated log entries.

In another embodiment the method further comprises reading a first set of blocks from the transaction log to the log record buffer, parsing each of the first set of blocks to identify a change record type and then identifying compensated log entries in the first set of blocks as log entries, which either were rolled back transactions or are compensated by later log entries using the change record type.

In another embodiment the modification of the transaction log is applied to the whole transaction log.

In another embodiment the modification of the transaction log is applied to a non-archive part of the transaction log.

In another embodiment the modification of the transaction log is applied incrementally to a stream of newly written log records.

In another embodiment the method further comprises repeatedly writing the modified transaction log to a log archive. The transaction log may, for example, be stored on a memory or storage device which is easily accessed by a computer system. For long term storage an archive, such as a tape or hard drive, may be used. The modified transaction log is then periodically copied to the log archive.

In another embodiment the method further comprises receiving a backup of the computer-implemented database. The method further comprises restoring the computer-implemented database using the backup, the modified transaction log and/or the log archive. Restoring the computer-implemented database may, for example, be performed well after the modification of the transaction log using the compensated log entries. This may, for example, enable acceleration of the restore process of the computer-implemented database.

Within the database management system (DBMS) or computer implemented database, concurrently running transactions will log the changes that they apply to the attributes of rows in database tables in order to recover from failures. After system failures, recovery may restore the last backup snapshot, read all transaction changes from the log that accumulated in the meantime, and applies them to the snapshot in order to recover the last consistent state before the failure.

A common database logging technique is write-ahead-logging (WAL), i.e., changes are written to a transaction log that resides on a persistent storage medium before committing the transaction. In order to reduce the overhead for transaction processing, uncommitted changes are, usually, written before commit, leading to a dirty log state that will be compensated during recovery. Compensation happens by filtering change records of uncommitted transactions and only applying changes of committed transaction in commit order.

The dirty log state wastes storage resources, which is critical as the log volume may be very large. Therefore, older logs are usually written onto some cheap but slow archive medium, such as tape. Accessing logs from the archive is orders of magnitude slower than access from local disk. Further, applying the compensation logic at recovery time increases the time until the DBMS becomes operable again after a failure. The mean time to recover is an important metric for evaluating the availability of the DBMS.

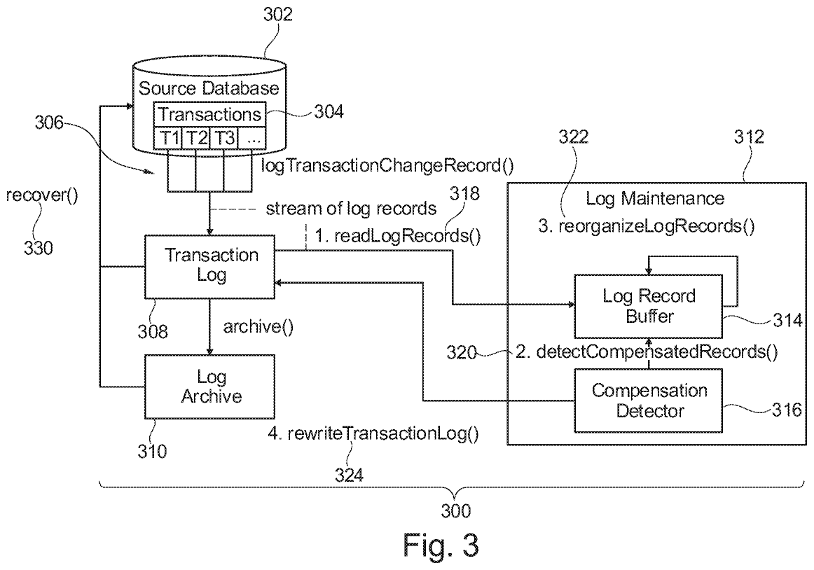

Embodiments may address the problem of dirty log states by introducing an asynchronous log maintenance component (cf. FIG. 3). The log maintenance reads component the transaction log stream and applies compensation logic, which is state-of-the-art in database replication products, in order to identify log records of transactions that have no effect and, thus, can be skipped during the recovery process. A log records may be skipped if, for example, it has been written by a transaction that did not commit but rolled back or if it encodes a change that has been overwritten by a subsequent transaction.

FIG. 3 illustrates an example of a computer implemented database 300 that is configured for rewriting the transaction log to eliminate or reduce the number of compensated log records. This database system 300 comprises a source database 302 or an implementation of a database. The computer implemented database 300 may, for example, be implemented using the computer system illustrated in FIGS. 1 and 2.

The source database 302 is shown as generating a number of transactions 304. This results in a stream of log records 306 being sent to a transaction log 308. The transaction log 308 is a temporary storage medium where transaction logs are accumulated. Eventually they are then written to a log archive 310. If the source database 302 needs to be restored or changes to the database 302 need to be rolled back, the transactions stored in the transaction log 308 and the log archive 310 can be used.

The database system 300 is further shown as comprising a log maintenance module 312. The log maintenance module comprises a log record buffer 314 and a compensation detector 316. The log record buffer 314 is configured to read the transaction log 308. The compensation detector 316 is configured for detecting compensated log entries in the log record buffer 314. Some pseudo code is also displayed in this Figure to illustrate a method. The first step is read log records 318. In this step, log records are read from the transaction log 308 to the log record buffer 314. Next, in the second step of this method, the detect compensated records function 320 is used and this causes the compensation detector 316 to detect compensated records in the log record buffer 314. After this, the log maintenance module 312 is then configured to reorganize the log records 322. This may, for example, be used for grouping log records and/or deleting compensated records. Finally, the reorganized log records are written from the compensation detector 316 to the transaction log 308 using the function rewrite transaction log 324.

The recovery operation method 330 may also be performed. In this case the contents of the transaction log 308 and/or the log archive 310 are used to restore the source database 302 or roll it back to a previous state.

In the example illustrated in FIG. 3, log compensated records will be physically removed from the transaction log, preferably before records are stored in the archive. That is, the whole transaction log may be rewritten, keeping only those change records that will have an effect during recovery. Thereby, the processing time for recovery is significantly reduced as well as the log data volume that needs to be stored inside the transaction log (archive). Further, by reordering the log records inside the transaction log, e.g., clustering them by table, the access locality for applying the changes is increased, which improves data access efficiency. However, more processing resources are required for executing the log maintenance compared to disclosure.

Several examples of how to rewrite the transaction log are given below.

In order to detect compensated log records, state-of-the-art techniques from database replication products can be used. The method may include one or more of the following steps:
1. Fill a temporary buffer with records from the transaction log by:

1.1. Reading a first set of blocks of log records from the transaction log B1.

1.2. Parsing the log records within each block of B1 to identify the change record type.
2. For all records within the buffer (scan in reverse order, independent of the original block):

2.1. Identify rolled-back transactions.

2.2. Identify attribute changes that compensate each other, e.g., insertion followed by deletion of the same data record.
3. Reorganize log records in the buffer to a second set of blocks B2.
4. Rewrite the transaction log, replacing B1 with B2 by, for example,

a) Removing all blocks of B1 and appending all blocks of B2.

b) Overwriting blocks of B1 with blocks of B2 and removing the remaining ones.

c) Overwriting blocks of B1 with blocks of B2 and keeping the remaining ones for re-use in subsequent iterations, finally pruning blocks that were freed during the rewriting process.

The above-mentioned steps, 1 through 4, may for example be applied to: to the whole transaction log, i.e., until it has been completely rewritten, to just the non-archived part to minimize impact due to log archive access, or incrementally to the stream of newly written log records in any combination thereof.

The log records may be physically reorganized. In the original log stream the records were ordered by creation time stamp, which is not optimal in the recovery case as the same data regions might have been modified by different transactions over a longer time frame. The main task of this physical reorganization step is to cluster log records, i.e., physically group similar records nearby in the physical record structure so that they appear in this sequence in the rewritten log stream. The main steps may include one or more of the following:
1. Prune log records that have been identified as compensated, e.g., by:

a. Marking them as logically deleted inside the buffer and skipping such marked records during the log rewriting phase.

b. Removing them from the buffer.
2. Sort the remaining records according to a clustering criterion, examples given,

a. Order the records by table that is affected by the corresponding change.

b. Order the records by table attribute that is affected by the corresponding change.

The modified transaction log may be used for the recovery of a database. For example, recovery procedure may be applied, i.e., reading the transaction log and applying the change records to the last consistent database snapshot or backup. Since the transaction log has been rewritten, the log data volume is significantly reduced because it does not contain compensated records anymore. Further, due to reorganization of the log stream, the records will be applied in a data-oriented sequence not time-oriented sequence anymore, which significantly increases access locality.

A common database logging technique is write-ahead-logging, i.e., changes are written to a transaction log that resides on a persistent storage medium before committing the transaction. In order to reduce the overhead for transaction processing, uncommitted changes are, usually, written before commit, leading to a dirty log state that will be compensated during recovery. Compensation happens by filtering change records of uncommitted transactions and only applying changes of committed transaction in commit order.

Instead of physically modifying the transaction log, it may also be logically or virtually modified. For example, a log record may be skipped if, for example, it has been written by a transaction that did not commit but rolled back or if it encodes a change that has been overwritten by a subsequent transaction.

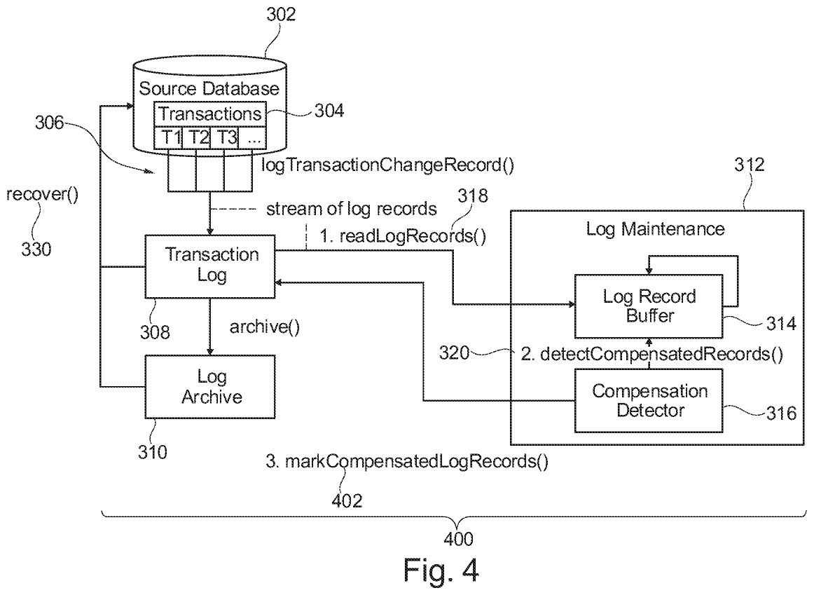

FIG. 4 illustrates a further example of a computer-implemented database 400. The computer-implemented database 400 in FIG. 4 is similar to the computer-implemented database 300 illustrated in FIG. 3. The components of the computer-implemented database system 400 are equivalent to those shown in FIG. 3; however, the system is configured differently. The system is again configured to perform the read log records method 318. The detect compensated record 320 is also performed again, however, instead of reorganizing the records in the transaction log, the log records are marked. The marked compensated log records method 402 is executed and either individual records within the transaction log are marked or an external file is used to virtually mark them.

Compensated log records may be logically marked as compensated, e.g., by setting a flag inside the log record header or inside the header of a larger block of many log records. By just marking log records as logically deleted minimizes the implementation impacts for modifying: the log data structure layout, the logic for writing and parsing log records, and/or the recovery logic.

A description of one way of logically or virtually modifying a transaction log is detailed below. The method may include one or more of the following steps:
1. Fill a temporary buffer with log records from the transaction log by:

1.1. Reading the stream of log records from the transaction log.

1.2. Parsing the log records to identify the change record type.
2. For records within the buffer (scan in reverse order):

2.1. Identify rolled-back transactions.

2.2. Identify attribute changes that compensate each other, e.g., insertion followed by deletion of the same data record.
3. For each compensated record in the buffer:

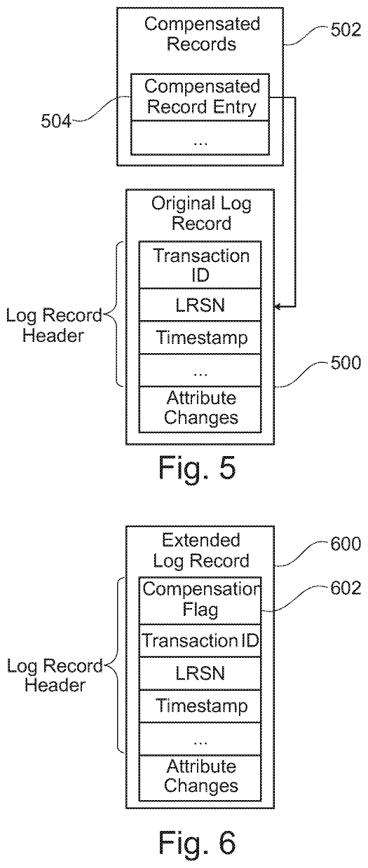

3.1. Mark the corresponding record inside the transaction log as compensated, for example, by (cf. FIGS. 5-7):

a) Storing an entry inside an auxiliary data structure, e.g., an index structure, that

is stored separately from the transaction log

uniquely identifies the compensated log record inside the transaction log

can be accessed in the same order as the transaction log for filtering

b) Setting a compensated flag inside the change record's header

c) Setting a compensated flag inside the header of a larger block of log records

3.2. This may require reformatting a log record in the transaction log, e.g., by extending it by adding additional header fields as is illustrated in FIG. 5 through 7.

FIG. 5 illustrates one way of marking compensated log records. In this example there is the original log record 500. Instead of modifying it an auxiliary data structure 502 is used. This may, for example, have an identification of the auxiliary data structure 504 that points to the original log record 500 that was identified as being a compensated log record. The auxiliary data structure 502 could, for example, be stored in the transaction log 308 or it may be stored in a different location within the computer system 10.

FIG. 6 shows a further means of marking a compensated log record. In this example, the log records are stored as extended log records 600. They have a compensation flag 602 which can be used to mark the extended log record 600 as either being a normal log record or a compensated log record. If the compensation flag 602 is set, then during the recovery process the particular extended log record 600 can be ignored.

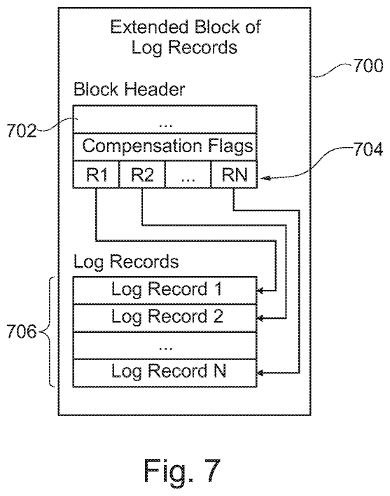

FIG. 7 shows a further means of marking compensated log records. In this example there is an extended block of log records 700 that comprises a block header 702 and individual log records 706. The block header 702 comprises a compensation flag 704 for each of the log records 706. When the extended block of log records 700 is read, then the block header 702 can easily be used to identify which of the log records 706 may be safely ignored.

Steps 1 through 3 of the method above may be applied: to the whole transaction log, i.e., until it has been completely processed, to just the non-archived part to minimize impact due to log archive access, and/or incrementally to the stream of newly written log records.

Once the transaction log has been modified logically or virtually, it may be used to recover or restore a database. This process may include one or more of the following steps:
1. Read and parse the log records from the transaction log
2. For each (block of) log record(s):

2.1. Lookup the record in the compensated record auxiliary structure.

2.2. If the log record is marked as compensated inside the auxiliary structure, skip the record/block.

2.3. Else, perform recovery actions for the record.

Alternatively, the auxiliary structure may be implemented as index on the transaction log that stores only entries for non-compensated records in the same order that is used in the transaction log, e.g., by ascending log record sequence number. In this case, the log can be read by traversing the index, which implicitly skips compensated entries. This process may include one or more of the following steps:
1. For remaining entry in the transaction log before the first position of the index (recent entries that have not been processed by the log maintenance task, yet):

1.1. Perform recovery for the record
2. For each record entry inside the index:

2.1. Lookup the corresponding log record inside the transaction log

2.2. Perform recovery actions for the record
3. For each remaining entry in the transaction log after the last position of the index (old entries that have not been processed by the log maintenance task, yet):

3.1. Perform recovery for the record

A method of recovering a database using embedded compensation information may include one or more of the following steps:
1. Read and parse the log records from the transaction log
2. For each (block of) log record(s)

2.1. Detect whether the record contains compensation information, e.g., by

a) Evaluating a version number

b) Evaluating the header size

2.2. If the log record contains compensation information

a) Skip the record/block if it is marked as compensated

b) Else, perform recovery actions for the record

2.3. Else (not processed by the asynchronous log maintenance task yet), perform recovery actions for the record.

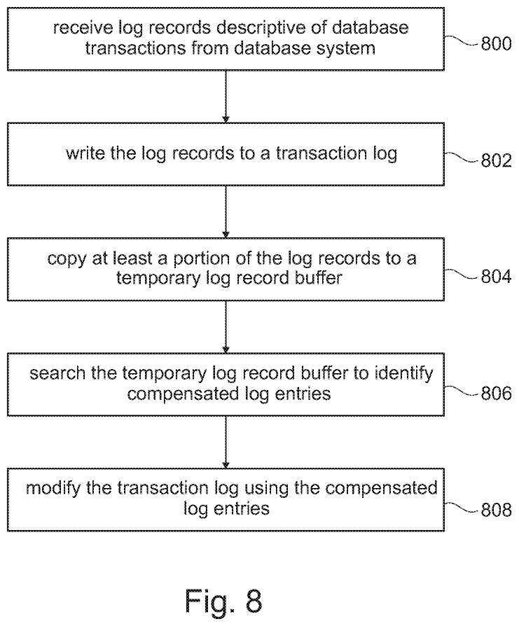

FIG. 8 shows a flowchart which illustrates a method of operating the computer-implemented databases 300, 400 illustrated in FIGS. 3 and 4. First, in step 800, the log records 306 are received from the computer-implemented database 300. Next, in step 802, the log records 306 are written to the transaction log 308. Then, in step 804, at least a portion of the log records 306 are read to a temporary log record buffer 314. Then, in step 806, the temporary log record buffer 314 is searched to identify compensated log entries. Finally, in step 808, the transaction log 308 is modified using the compensated log entries. This may actually involve the deletion of records or it may involve marking them virtually.

What is claimed is:

1. A method of operating a computer implemented database, the method comprising:
receiving log records descriptive of database transactions from the computer implemented database;
writing the log records to a transaction log;
reading at least a portion of the log records to a temporary log record buffer;
searching the temporary log record buffer to identify compensated log entries; and
modifying the transaction log using the compensated log entries.

2. The method of claim 1, wherein modifying the transaction log using the compensated log entries comprises removing at least a portion of the compensated log entries from the transaction log.

3. The method of claim 1, wherein reading at least a portion of the log records to a temporary log record buffer comprises reading a first set of blocks from the transaction log to the log record buffer and parsing each of the first set of blocks to identify a change record type, and wherein searching of the temporary log record buffer to identify compensated log entries comprises identifying compensated log entries in the first set of blocks as log entries which either rolled back transactions or are compensated by later log entries using the change record type; and wherein modifying the transaction log using the compensated log entries comprises constructing a second set of blocks by removing the compensated log entries from the first set of blocks and replacing the first set of blocks in the transaction log with the second set of blocks.

4. The method of claim 3, wherein replacing the first set of blocks in the transaction log with the second set of blocks comprises any one of the following:
removing the first set of blocks and appending the second set of blocks to the transaction log;
overwriting the first set of blocks with the second set of blocks, preferably removing portions of the first set of blocks not overwritten by the second set of blocks; and
overwriting the first set of blocks with the second set of blocks, preferably retaining the portions of the first set of blocks not overwritten by the second set of blocks.

5. The method of claim 3, wherein the method further comprises:
sorting and grouping of log entries of the second set of blocks according to a clustering criterion.

6. The method of claim 5, wherein sorting and grouping of the second set of blocks is performed using a hash table sorting algorithm.

7. The method of claim 5, wherein the clustering criterion is selected to order the log entries of the second set of blocks to order records by a table that is affected by a corresponding change or by a table attribute that is affected by the corresponding change.

8. The method of claim 5, wherein the method further comprises executing clustered log entries in the second set of blocks as a single operation during restoring the computer implemented database.

9. The method of claim 1, wherein modifying the transaction log using the compensated log entries comprises identifying the compensated log entries in the transaction log.

10. The method of claim 9, wherein identifying the compensated log entries in the transaction log comprises storing an identification of the compensated log entries as an auxiliary data structure stored separately from the transaction log, and wherein modifying of the transaction log comprises a logical modification of the transaction log.

11. The method of claim 10, wherein during a restoration of the computer implemented database the method further comprises:
accessing the auxiliary data structure during accessing the transaction log to identify the compensated log entries; and
skipping the compensated log entries during restoration of the computer implemented database.

12. The method of claim 9, wherein identifying the compensated log entries in the transaction log comprises storing an identification of the compensated log entries in the transaction log.

13. The method of claim 12, wherein the compensated log entries in the transaction log are identified logically by using block header fields, by using log record headers, or by using compensated record entries.

14. The method of claim 9, wherein the method further comprises:
reading a first set of blocks from the transaction log to the log record buffer;
parsing each of the first set of blocks to identify a change record type; and
identifying compensated log entries in the first set of blocks as log entries which either rolled back transactions or are compensated by later log entries using the change record type.

15. The method of claim 1, wherein modifying the transaction log using the compensated log entries is applied to any one of the following: to the whole transaction log, to a non-archived part of the transaction log, incrementally to a stream of newly written log records, and combinations thereof.

16. The method of claim 1, wherein the method further comprises:
repeatedly writing the modified transaction log to a log archive.

17. The method of claim 1, wherein the method further comprises:
receiving a backup of the computer implemented database; and
restoring the computer implemented database using the backup, the modified transaction log, and the log archive.

18. A computer program product for operating a computer implemented database, the computer program product comprising:
one or more computer-readable tangible storage devices and program instructions stored on at least one of the one or more computer-readable tangible storage devices, wherein the program instructions are executable by a computer, the program instructions comprising:
program instructions to receive log records descriptive of database transactions from the computer implemented database;
program instructions to write the log records to a transaction log;
program instructions to read at least a portion of the log records to a temporary log record buffer;
program instructions to search the temporary log record buffer to identify compensated log entries; and
program instructions to modify the transaction log using the compensated log entries.

19. A computer system for operating a computer implemented database, the computer system comprising:
one or more processors, one or more computer-readable memories, one or more computer-readable tangible storage devices, and program instructions stored on at least one of the one or more computer-readable tangible storage devices for execution by at least one of the one or more processors via at least one of the one or more memories, the program instructions comprising:
program instructions to receive log records descriptive of database transactions from a source database;
program instructions to write the log records to a transaction log;
program instructions to read at least a portion of the log records to a temporary log record buffer;
program instructions to search the temporary log record buffer to identify compensated log entries; and
program instructions to modify the transaction log using the compensated log entries.
